(19) United States
(12) Patent Application Publication
(10) Pub. No.: US 2021/0333123 A1
(43) Pub. Date: Oct. 28, 2021

(54) NAVIGATION DEVICE, SERVER, AND NAVIGATION METHOD

(71) Applicant: MITSUBISHI ELECTRIC CORPORATION, Tokyo (JP)

(72) Inventors: Hiroki Ebina, Tokyo (JP); Mitsuo Shimotani, Tokyo (JP)

(73) Assignee: MITSUBISHI ELECTRIC CORPORATION, Tokyo (JP)

(21) Appl. No.: 16/479,854

(22) PCT Filed: Feb. 17, 2017
(86) PCT No.: PCT/JP2017/005853

§ 371 Date: Jul. 22, 2019

(51) Int. Cl. G01C 21/36

(52) U.S. Cl. CPC G01C 21/3667; G01C 21/3691

(57) ABSTRACT

The output timing of the guidance information about a guide point in which the occurrence of a light irradiation state in which the driver of a vehicle feels dazzled is predicted is changed to a second timing earlier than a first timing predetermined for the guide point.

### TECHNICAL FIELD

The present invention relates to a navigation device for, a server for, and a navigation method of providing guidance about a route of a vehicle.

### BACKGROUND ART

Conventionally, a technique of determining whether the sunlight acts as backlight with respect to the field of view of the driver of a vehicle, and, when determining that the sunlight acts as backlight, causing equipment in the vehicle to operate in such a way that the influence of the backlight is reduced is known. For example, in a driving supporting device described in Patent Literature 1, when it is determined that the sunlight acts as backlight with respect to the field of view of the driver, the position of a sun visor is moved to the driver's visual field range, or the color of window glass is changed to darker.

### CITATION LIST

### Patent Literature

Patent Literature 1: Japanese Unexamined Patent Application Publication No. 2013-54545

### SUMMARY OF INVENTION

### Technical Problem

However, although the driving supporting device described in Patent Literature 1 takes measures against backlight when it is determined that the sunlight acts as backlight with respect to the field of view of the driver, the driving supporting device does not predict whether backlight occurs at a point to which the vehicle is moving. Therefore, a problem is that even though the driving supporting device described in Patent Literature 1 is used, it is impossible to provide route guidance adapting to a light irradiation state at a guide point to which the vehicle is moving.

The present invention is made in order to solve the above-mentioned problem, and it is therefore an object of the present invention to provide a navigation device, a server, and a navigation method capable of providing route guidance adapting to a light irradiation state at a guide point to which a vehicle is moving.

### Solution to Problem

A navigation device according to the present invention includes a route guiding unit, a detecting unit, a predicting unit, and a guidance timing adjusting unit.

The route guiding unit outputs guidance information about a guide point on a route. The detecting unit detects a light irradiation state with respect to a vehicle. The predicting unit predicts whether a light irradiation state in which the driver feels dazzled will occur at a guide point to which the vehicle is moving, on the basis of the light irradiation state detected by the detecting unit. The guidance timing adjusting unit changes the output timing of the guidance information about the guide point in which the occurrence of the light irradiation state in which the driver feels dazzled is predicted by the predicting unit, to a second timing earlier than a first timing predetermined for the guide point.

### Advantageous Effects of Invention

According to the present invention, the output timing of the guidance information about the guide point in which the occurrence of the light irradiation state in which the driver feels dazzled is predicted is changed to the second timing earlier than the first timing. As a result, it is possible to provide route guidance adapting to a light irradiation state at a guide point to which the vehicle is moving.

### BRIEF DESCRIPTION OF DRAWINGS

FIG. 1 is a block diagram showing the configuration of a navigation device according to Embodiment 1 of the present invention;

FIG. 2A is a block diagram showing a hardware configuration for implementing the functions of the navigation device according to Embodiment 1;

FIG. 2B is a block diagram showing a hardware configuration for executing software that implements the functions of the navigation device according to Embodiment 1;

FIG. 3 is a flow chart showing a navigation method according to Embodiment 1;

FIG. 4A is a view showing an outline of a process of adjusting a guidance timing in Embodiment 1;

FIG. 4B is a view showing an example of a guidance screen in Embodiment 1;

FIG. 4C is a view showing another example of the guidance screen in Embodiment 1;

FIG. 5 is a flow chart showing another example of the navigation method according to Embodiment 1; and

FIG. 6 is a block diagram showing the configurations of a server and a vehicle-mounted device according to Embodiment 2 of the present invention.

### DESCRIPTION OF EMBODIMENTS

Hereafter, in order to explain the present invention in greater detail, embodiments of the present invention will be described with reference to the accompanying drawings.

### Embodiment 1

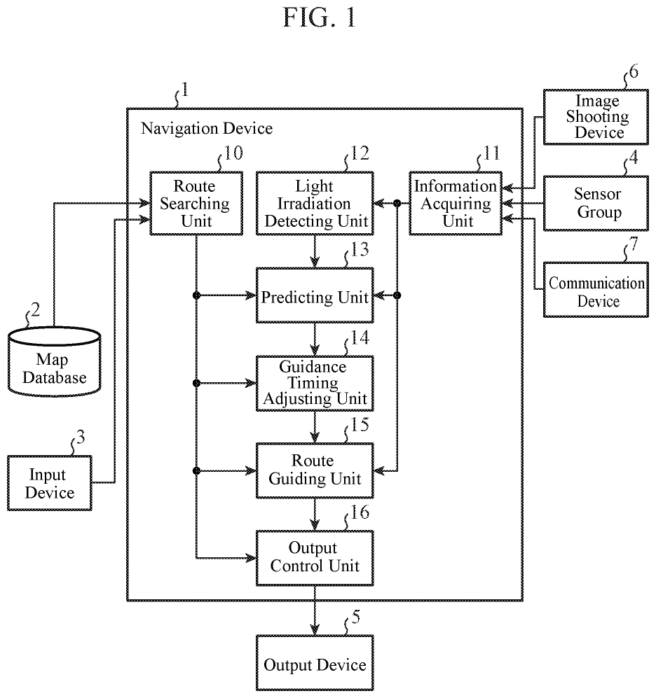

FIG. 1 is a block diagram showing the configuration of a navigation device 1 according to Embodiment 1 of the present invention. The navigation device 1 is a car navigation device mounted and used in a vehicle, and is connected to a map database 2, an input device 3, a sensor group 4, an output device 5, an image shooting device 6, and a communication device 7.

The navigation device 1 can be fixed to the vehicle, or can be a terminal device that is carried into the vehicle by an occupant. For example, the navigation device can be a terminal device such as a smartphone or a tablet PC.

The map database 2 is a database in which map data used fora map display in navigation processing is recorded. Further, in road data included in the map data, data showing attributes of roads, connections of the roads, etc. is included.

The input device 3 receives input of information to, an instruction for, and an operation on the navigation device 1. For example, destination information is inputted to the navigation device 1 using the input device 3.

The sensor group 4 includes multiple sensors that the vehicle has. The sensor group 4 includes, for example, a direction sensor for detecting the direction of the vehicle, a speed sensor for detecting the speed of the vehicle, and a position sensor for detecting the position of the vehicle.

The output device 5 outputs data from the navigation device 1 visually and acoustically.

The image shooting device 6 includes cameras for shooting images of an inside and an outside of the vehicle. The image shooting device 6 includes a camera for outside of vehicle and a camera for inside of vehicle, the camera for outside of vehicle shooting an image of an area surrounding the vehicle, the camera for inside of vehicle shooting an image of the driver in the vehicle.

The communication device 7 receives information related to the influence of the sunlight on the vehicle from an external device, and outputs the information to the navigation device 1. In the above-mentioned information received by the communication device 7, for example, weather information about an area surrounding the vehicle, and position information about the sun with respect to the vehicle position and the time are included.

The navigation device 1 searches for a route to a destination on the basis of the map data recorded in the map database 2, the destination information inputted using the input device 3, and the position information about the vehicle detected by the sensor group 4, and provides guidance on the route searched for.

In the route guidance, the driver is notified of guidance information about a guide point to which the vehicle is moving at a timing predetermined for this guide point. The guide point is an intersection or the like on the route. The guidance information is information indicating a way of driving the vehicle along the route. For example, when a guide route requires a right-hand turn at an intersection, the driver is notified of, as the guidance information, information indicating a right-hand turn.

Further, in the navigation device 1, the guidance information about a guide point in which the occurrence of a light irradiation state in which the driver of the vehicle feels dazzled is predicted is outputted at a timing earlier than the timing predetermined for the guide point.

It is generally assumed that the driver starts to check the situation of the guide point related to the guidance information in detail after this guidance information is notified by the navigation device 1. Therefore, when the guidance information is outputted at an earlier timing, the time which the driver can use to check the light irradiation state increases.

As a result, outputting the guidance information at an earlier timing enables the driver to recognize the light irradiation state by the time the vehicle reaches the guide point, and thus the driver can drive the vehicle in accordance with the guidance information while recognizing this irradiation state.

The navigation device 1 includes, as a functional configuration thereof, a route searching unit 10, an information acquiring unit 11, a light irradiation detecting unit 12, a predicting unit 13, a guidance timing adjusting unit 14, a route guiding unit 15, and an output control unit 16, as shown in FIG. 1.

The route searching unit 10 searches for a travel route (described as a guide route hereafter) connecting a place of departure and a destination on the basis of the map data recorded in the map database 2, the destination information inputted using the input device 3, and the position information about the vehicle detected by the sensor group 4.

The information acquiring unit 11 acquires pieces of information acquired by the sensor group 4, the image shooting device 6, and the communication device 7. For example, pieces of information detected by the sensor group 4 and showing the direction, the vehicle speed, and the position of the vehicle are acquired, pieces of image information about images of an inside and an outside of the vehicle, the images being shot by the image shooting device 6, are acquired, and information related to the influence of the sunlight on the vehicle and received by the communication device 7 is acquired.

The light irradiation detecting unit 12 is a detecting unit that detects alight irradiation state with respect to the vehicle.

For example, the light irradiation detecting unit 12 detects a light irradiation state in a fixed range extending along the guide route from the current position of the vehicle, on the basis of the pieces of information acquired by the information acquiring unit 11.

As the light irradiation state, the position of the sun in the above-mentioned fixed range with respect to the vehicle is detected, and a state of irradiation of the vehicle with lamp light from an opposite vehicle is detected. The position of the sun with respect to the vehicle means the direction and the elevation angle of the sun viewed from the surface of the earth.

The predicting unit 13 predicts whether a light irradiation state in which the driver feels dazzled will occur at a guide point to which the vehicle is moving, on the basis of the light irradiation state detected by the light irradiation detecting unit 12. For example, the predicting unit 13 determines that the driver's position and direction approximate the position and the direction of movement of the vehicle, and predicts a light irradiation state with respect to the driver's position and direction at the nearest guide point in the above-mentioned fixed range.

For example, when at the guide point, the sunlight acts as backlight with respect to the field of view of the driver, the predicting unit 13 predicts that a light irradiation state in which the driver feels dazzled will occur, and outputs a result of the prediction to the guidance timing adjusting unit 14. Further, when other vehicles with high beam headlamps being turned on are traveling continuously in an opposite lane of the road along which the vehicle travels toward the guide point, the predicting unit 13 predicts that a light irradiation state in which the driver feels dazzled will occur at the guide point.

The guidance timing adjusting unit 14 changes the output timing of the guidance information about the guide point in which the occurrence of a light irradiation state in which the driver feels dazzled is predicted by the predicting unit 13, to a second timing earlier than a first timing predetermined for the guide point.

The first timing at which to output the guidance information is predetermined in route information which is searched for by the route searching unit 10. For example, when the guide point is an intersection, it is predetermined that the guidance information is to be outputted at a position 200m before the intersection. When it is predicted that a light irradiation state in which the driver feels dazzled will occur at this intersection, the output timing changes from the predetermined output timing to an output timing causing the guidance information to be outputted at a position 500m before the intersection.

The route guiding unit 15 guides the vehicle to the destination along the guide route. For example, the route guiding unit 15 superimposes the guide route on a map screen, and outputs the guidance information about the guide point on the guide route at the timing predetermined for the guide point. However, when it is predicted that a light irradiation state in which the driver feels dazzled will occur at the guide point, the route guiding unit 15 outputs the guidance information at the timing changed by the guidance timing adjusting unit 14.

The output control unit 16 causes the output device 5 to output the guidance information inputted from the route guiding unit 15.

For example, when it is necessary to provide guidance showing a right-hand turn at an intersection, image information for urging the driver to make a right-hand turn is displayed, as the guidance information, on a display, and voice guidance for urging the driver to make a right-hand turn is outputted by voice from a speaker.

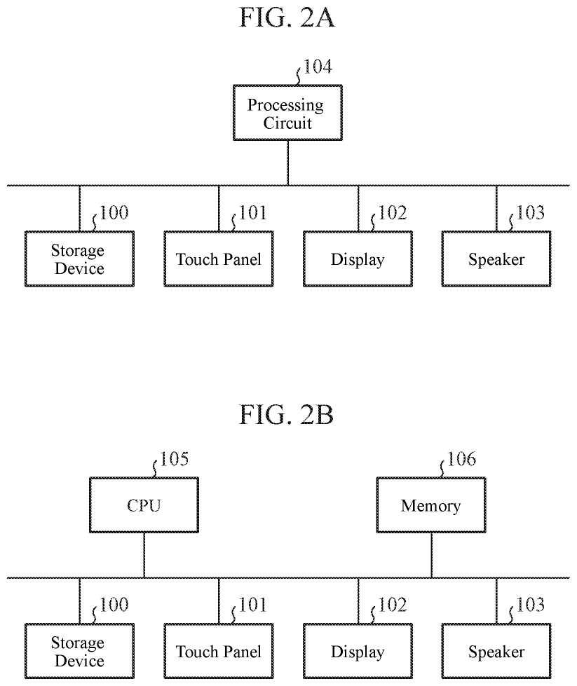

FIG. 2A is a block diagram showing a hardware configuration for implementing the functions of the navigation device 1. In FIG. 2A, a storage device 100, a touch panel 101, a display 102, a speaker 103, and a processing circuit 104 are connected to one another.

FIG. 2B is a block diagram showing a hardware configuration for executing software that implements the functions of the navigation device 1. In FIG. 2B, a storage device 100, a touch panel 101, a display 102, a speaker 103, a Central Processing Unit (CPU) 105, and a memory 106 are connected to one another.

In FIGS. 2A and 2B, the storage device 100 stores the map database 2 shown in FIG. 1. The storage device 100 can be made of, for example, a Random Access Memory (RAM), a Read Only Memory (ROM), a flash memory, a Hard Disk Drive (HDD), or the like, or can be a storage device made of a combination of two or more thereof. Further, part or all of the storage areas of the storage device 100 can be provided in an external storage device. In this case, map data is transmitted and received by communication between the navigation device 1 and the above-mentioned external storage device via, for example, a communication line such as the Internet or an intranet.

The touch panel 101 is a device that provides the input device 3 shown in FIG. 1.

The input device 3 has only to receive input of information to, an instruction for, and an operation on the navigation device 1, and can be hardware buttons, a keyboard, a mouse, or the like. The display 102 and the speaker 103 are devices that provide the output device 5 shown in FIG. 1. For example, the display 102 displays map data used for navigation processing together with the guide route. The voice guidance is outputted by voice by the speaker 103.

Each of the functions of the route searching unit 10, the information acquiring unit 11, the light irradiation detecting unit 12, the predicting unit 13, the guidance timing adjusting unit 14, the route guiding unit 15, and the output control unit 16 in the navigation device 1 is implemented by a processing circuit. More specifically, the navigation device 1 includes a processing circuit for performing these functions. The processing circuit can be hardware for exclusive use, or a CPU that executes a program stored in a memory.

In a case in which the above-mentioned processing circuit is the processing circuit 104 that is shown in FIG. 2A and that is hardware for exclusive use, the processing circuit 104 is, for example, a single circuit, a composite circuit, a programmable processor, a parallel programmable processor, an Application Specific Integrated Circuit (ASIC), a Field-Programmable Gate Array (FPGA), or a combination of two or more thereof.

The functions of the route searching unit 10, the information acquiring unit 11, the light irradiation detecting unit 12, the predicting unit 13, the guidance timing adjusting unit 14, the route guiding unit 15, and the output control unit 16 in the navigation device 1 can be implemented by respective processing circuits, or the functions can be implemented collectively by a single processing circuit.

Ina case in which the above-mentioned processing circuit is the CPU 105 shown in FIG. 2B, each of the functions of the route searching unit 10, the information acquiring unit 11, the light irradiation detecting unit 12, the predicting unit 13, the guidance timing adjusting unit 14, the route guiding unit 15, and the output control unit 16 is implemented by software, firmware, or a combination of software and firmware. The software and the firmware are described as programs and are stored in the memory 106.

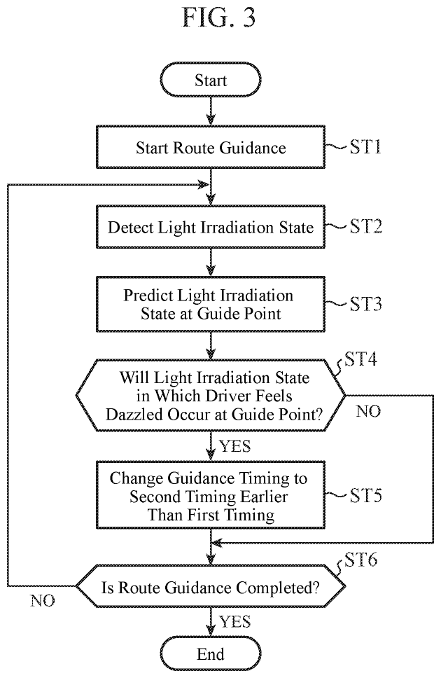

The CPU 105 implements each of the functions by reading and executing a program stored in the memory 106. More specifically, the navigation device 1 includes the memory 106 for storing programs by which processes insteps ST1 to ST6 shown in FIG. 3 mentioned later are performed as a result when the programs are executed by the CPU 105. These programs cause a computer to perform procedures or methods that the route searching unit 10, the information acquiring unit 11, the light irradiation detecting unit 12, the predicting unit 13, the guidance timing adjusting unit 14, the route guiding unit 15, and the output control unit 16 use.

The memory is, for example, a non-volatile or volatile semiconductor memory, such as a RAM, a ROM, a flash memory, an Erasable Programmable ROM (EPROM), and an Electrically EPROM (EEPROM), a magnetic disk, a flexible disk, an optical disk, a compact disk, a mini disk, a Digital Versatile Disk (DVD), or the like.

Further, a part of the functions of the route searching unit 10, the information acquiring unit 11, the light irradiation detecting unit 12, the predicting unit 13, the guidance timing adjusting unit 14, the route guiding unit 15, and the output control unit 16 can be implemented by hardware for exclusive use, and another part of the functions can be implemented by software or firmware.

For example, the functions of the route searching unit 10, the information acquiring unit 11, and the light irradiation detecting unit 12 are implemented by the processing circuit that is hardware for exclusive use. The functions of the predicting unit 13, the guidance timing adjusting unit 14, the route guiding unit 15, and the output control unit 16 are implemented by the CPU 105's execution of programs stored in the memory 106.

In this way, the processing circuit can implement the above-mentioned functions by using hardware, software, firmware, or a combination of two or more thereof.

### Operation

FIG. 3 is a flow chart showing a navigation method according to Embodiment 1, and shows a series of processes for route guidance adapting to a light irradiation state at a guide point.

First, the route guiding unit 15 starts guidance for the vehicle along the guide route that is searched for by the route searching unit 10 (step ST1).

In step ST2, the light irradiation detecting unit 12 detects a light irradiation state in the fixed range extending along the guide route from the current position of the vehicle, on the basis of the pieces of information acquired by the information acquiring unit 11. As a result, a light irradiation state with respect to the vehicle in the fixed range on the guide route is detected, the fixed range including the current position of the vehicle.

Next, the predicting unit 13 predicts whether a light irradiation state in which the driver feels dazzled will occur at a guide point to which the vehicle is moving, on the basis of the light irradiation state detected by the light irradiation detecting unit 12 (step ST3). The light irradiation state in which the driver feels dazzled includes a state in which the sunlight acts as backlight with respect to the field of view of the driver, and a state in which the driver is irradiated with direct light from a headlamp of an opposite vehicle.

For example, the predicting unit 13 determines the direction of movement of the vehicle at the guide point from the guidance information, and determines that the driver's position and direction approximate the position of the guide point and the determined direction of movement. Then, the predicting unit 13 determines whether the sunlight acts as backlight with respect to the driver's position and direction determined by the approximation, on the basis of the direction and the elevation angle of the sun which are detected by the light irradiation detecting unit 12. When it is determined that the sunlight acts as backlight, the predicting unit 13 outputs a prediction result showing that a light irradiation state in which the driver feels dazzled will occur at the guide point to the guidance timing adjusting unit 14.

Further, when opposite vehicles with high beam headlamps being turned on are traveling continuously in the fixed range on the guide route, the light irradiation detecting unit 12 transmits, as detection information about a light irradiation state, information showing this situation to the predicting unit 13. The fixed range includes the current position of the vehicle. When receiving this detection information, the predicting unit 13 predicts that a light irradiation state in which the driver feels dazzled will occur at the guide point.

When a prediction result showing that a light irradiation state in which the driver feels dazzled will not occur at the guide point is acquired (NO in step ST4), the process proceeds to step ST6.

When a prediction result showing that a light irradiation state in which the driver feels dazzled will occur at the guide point is acquired (YES in step ST4), a guidance timing adjusting unit 14 changes the guidance timing to the second timing earlier than the first timing (step ST5). The guidance timing is one at which to output the guidance information about the guide point.

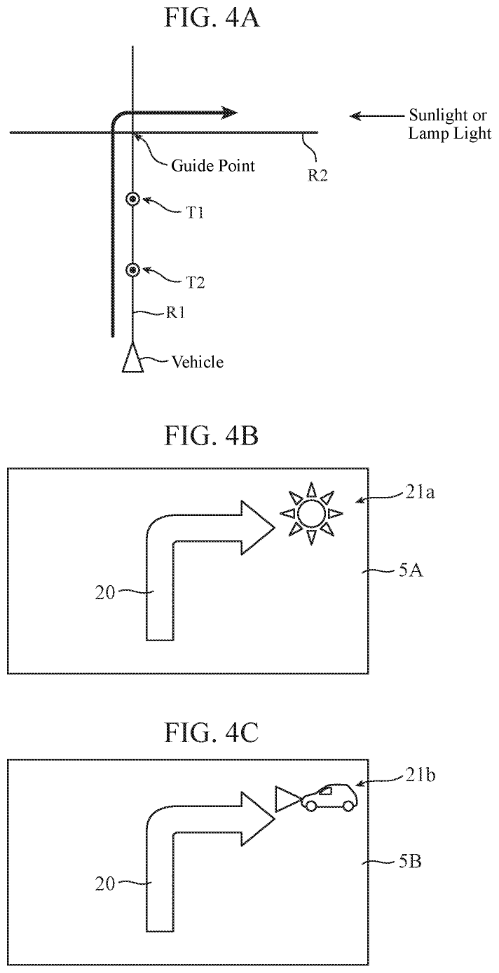

FIG. 4A is a view showing an outline of the process of adjusting the guidance timing. In FIG. 4A, a timing T1 is predetermined, as a timing at which to output the guidance information about an intersection, in the route information generated by the route searching unit 10. The guidance information about this intersection has a description showing that the vehicle entering the intersection from a road R1 is urged to make a right-hand turn toward a road R2.

In the example of FIG. 4A, when the vehicle makes a right-hand turn toward the road R2, the vehicle is irradiated with the sunlight or lamp light from an opposite vehicle. Thus, the predicting unit 13 predicts that a light irradiation state in which the driver feels dazzled will occur at this intersection.

When receiving a prediction result showing that a light irradiation state in which the driver feels dazzled will occur at the intersection, the guidance timing adjusting unit 14 changes the timing at which to output the guidance information about this intersection to a timing T2 earlier than the timing T1.

The route guiding unit 15 outputs the guidance information about the intersection to the output control unit 16 at the timing T2 changed by the guidance timing adjusting unit 14.

The output control unit 16 causes the output device 5 to output the guidance information inputted from the route guiding unit 15.

FIG. 4B is a view showing an example of a guidance screen 5A in Embodiment 1. In FIG. 4B, the output device 5 displays an arrow image 20 showing a right-hand turn on the guidance screen 5A.

Further, image information showing a cause that makes the driver feel dazzled can be displayed on the guidance screen 5A together with the guidance information. For example, the route guiding unit 15 generates image information 21a showing the cause that makes the driver feel dazzled, and outputs the image information to the output control unit 16 together with the guidance information. The output control unit 16 causes this image information 21a to be displayed on the guidance screen 5A together with the arrow image 20 showing a right-hand turn.

In the example of FIG. 4B, because the cause that makes the driver feel dazzled is backlight provided by the sunlight, the image information 21a showing the sun is displayed.

FIG. 4C is a view showing a guidance screen 5B in Embodiment 1. In FIG. 4C, because the cause that makes the driver feel dazzled is lamp light from an opposite vehicle, image information 21b showing the opposite vehicle is displayed on the guidance screen 5B together with the arrow image 20 showing a right-hand turn.

In FIGS. 4B and 4C, although the case in which the information showing the cause that makes the driver feel dazzled is outputted visually is shown, the information can be outputted acoustically. For example, voice guidance can announce that guidance is outputted earlier than predetermined because it is predicted that the sunlight will act as backlight.

This enables the driver to check the situation of the guide point while recognizing the cause that makes the driver feel dazzled. As a result, the driver can recognize a light irradiation state precisely by the time the vehicle reaches the guide point, and thus the driver can drive the vehicle in accordance with the guidance information while recognizing this irradiation state.

The explanation returns to FIG. 3. When the output of the guidance information as mentioned above is completed, the route guiding unit 15 checks whether the route guidance is completed (step ST6).

When the route guidance is completed (YES in step ST6), the route guiding unit 15 ends the processing. When the route guidance is not completed (NO in step ST6), the process returns to step ST2 and the series of processes mentioned above is repeated.

The process can be changed in accordance with whether the driver has taken a measure to prevent dazzling light.

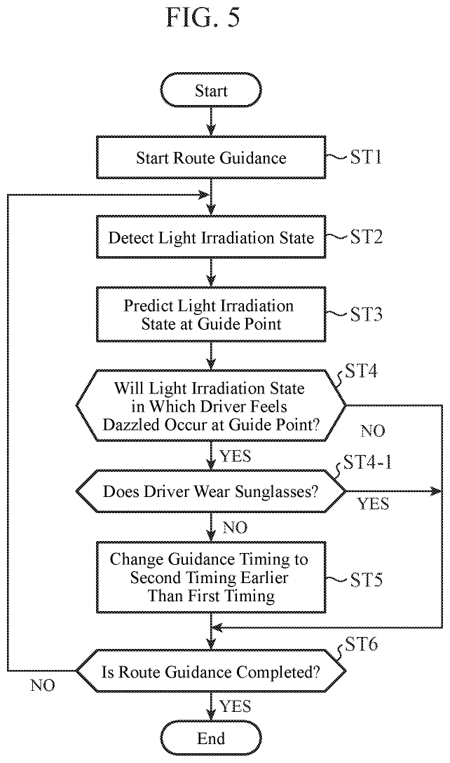

FIG. 5 is a flow chart showing another example of the navigation method according to Embodiment 1, and includes the process of determining the presence or absence of the driver's measure to prevent dazzling light.

The processes in steps ST1 to ST6 of FIG. 5 are the same as those shown in FIG. 3. FIG. 5 differs in that step ST4-1 is inserted after step ST4.

When a prediction result showing that a light irradiation state in which the driver feels dazzled will occur at the guide point is acquired (YES in step ST4), the light irradiation detecting unit 12 detects whether the driver wears sunglasses (step ST4-1). For example, the light irradiation detecting unit 12 performs an image analysis on a shot image of the driver, the image being acquired by the information acquiring unit 11, to detect whether the driver wears sunglasses.

When it is detected that the driver does not wear sunglasses (NO in step ST4-1), the light irradiation detecting unit 12 outputs detection information showing this fact to the guidance timing adjusting unit 14.

When the driver does not wear sunglasses, the guidance timing adjusting unit 14 changes the guidance timing to the second timing earlier than the first timing (step ST5).

In contrast, when it is detected that the driver wears sunglasses (YES in step ST4-1), the process proceeds to step ST6 without passing through step ST5.

More specifically, when the driver wears sunglasses, the guidance timing adjusting unit 14 does not change the guidance timing from the first timing.

By doing in this way, the guidance timing can be prevented from being changed unnecessarily when the driver does not feel dazzled.

Although the light irradiation detecting unit 12 detects whether the driver wears sunglasses, the target for the detection is not limited to sunglasses. For example, the light irradiation detecting unit 12 can detect whether the sun visor in front of the driver is lowered, or can detect whether the color of the window glass has been changed to darker. In short, any measure to prevent the driver from feeling dazzled can be the target for the detection.

As mentioned above, the navigation device 1 according to Embodiment 1 changes the output timing of the guidance information about a guide point in which the occurrence of a light irradiation state in which the driver of the vehicle feels dazzled is predicted to the second timing earlier than the first timing predetermined for the guide point.

Particularly, the predicting unit 13 predicts whether there will occur, at the guide point, one of a state in which the sunlight acts as backlight with respect to the field of view of the driver and a state in which the driver is irradiated with lamp light from an opposite vehicle.

This configuration makes it possible to provide route guidance adapting to alight irradiation state at a guide point to which the vehicle is moving.

For example, outputting the guidance information at an earlier timing enables the driver to recognize a light irradiation state by the time the vehicle reaches the guide point, and thus the driver can drive the vehicle in accordance with the guidance information while recognizing this irradiation state.

In the navigation device 1 according to Embodiment 1, the route guiding unit 15 outputs the information showing the cause that makes the driver feel dazzled together with the guidance information. This configuration enables the driver to check the situation of the guide point while recognizing the cause that makes the driver feel dazzled. As a result, the driver can recognize a light irradiation state precisely by the time the vehicle reaches the guide point, and thus the driver can drive the vehicle in accordance with the guidance information while recognizing this irradiation state.

In the navigation device 1 according to Embodiment 1, the light irradiation detecting unit 12 detects whether the driver takes a measure to prevent dazzling light. When the light irradiation detecting unit 12 detects that the driver takes the measure to prevent dazzling light, the guidance timing adjusting unit 14 does not change the output timing of the guidance information about a guide point to which the vehicle is moving from the predetermined first timing.

By this configuration, the guidance timing can be prevented from being changed unnecessarily when the driver does not feel dazzled.

### Embodiment 2

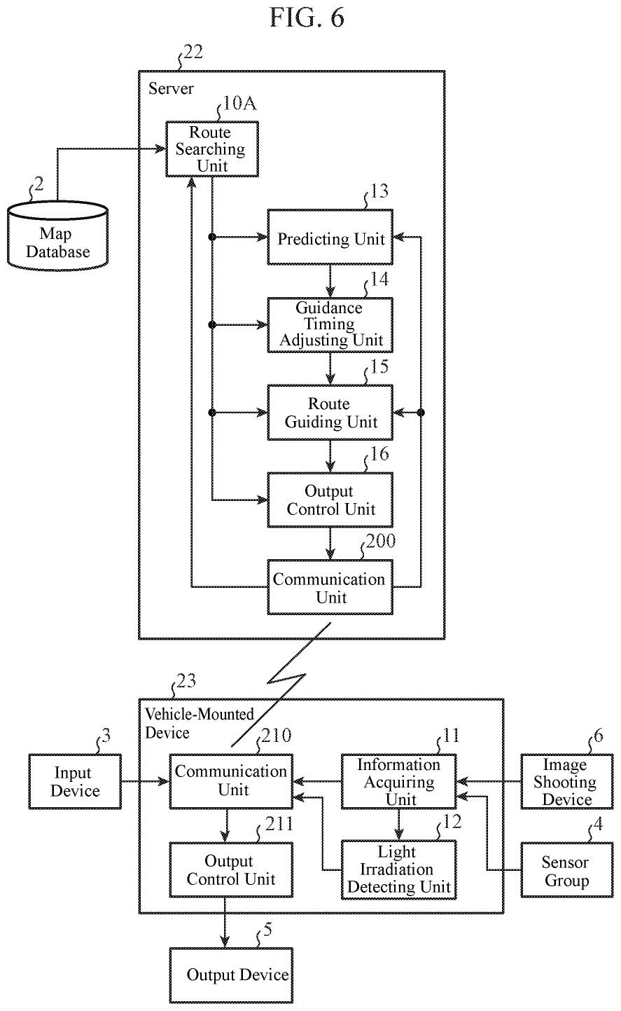

FIG. 6 is a block diagram showing the configurations of a server 22 and a vehicle-mounted device 23 according to Embodiment 2 of the present invention. In FIG. 6, the same components as those shown in FIG. 1 are denoted by the same reference numerals, and explanations of the components will be omitted. The server 22 includes a route searching unit 10A, a predicting unit 13, a guidance timing adjusting unit 14, a route guiding unit 15, an output control unit 16, and a communication unit 200. The vehicle-mounted device 23 includes an information acquiring unit 11, a light irradiation detecting unit 12, a communication unit 210, and an output control unit 211.

The route searching unit 10A searches for a guide route connecting a place of departure and a destination on the basis of map data recorded in a map database 2, destination information received by the communication unit 200 from the vehicle-mounted device 23, and position information about a vehicle received by the communication unit 200 from the vehicle-mounted device 23.

The communication unit 200 communicates with the vehicle-mounted device 23 to transmit and receive various pieces of information.

For example, the communication unit 200 transmits route information about the guide route and information showing the output timing of guidance information to the vehicle-mounted device 23, and receives the destination information about the vehicle, information acquired by the information acquiring unit 11, and detection information of the light irradiation detecting unit 12 from the vehicle-mounted device 23.

The communication unit 210 communicates with the server 22, to transmit and receive various pieces of information.

For example, the communication unit 210 transmits the destination information inputted using an input device 3, the information acquired by the information acquiring unit 11, and the detection information of the light irradiation detecting unit 12 to the server 22, and receives the route information about the guide route and the information showing the output timing of the guidance information from the server 22.

The output control unit 211 causes an output device 5 to output the route information and the guidance information which are received from the server 22 by the communication unit 210.

As mentioned above, the server 22 according to Embodiment 2 changes the output timing of the guidance information about a guide point in which the occurrence of a light irradiation state in which the driver of the vehicle feels dazzled is predicted to a second timing earlier than a first timing predetermined for the guide point. This configuration also makes it possible to provide route guidance adapting to a light irradiation state at a guide point to which the vehicle is moving.

It is to be understood that a combination of the above-mentioned embodiments can be made freely, various changes can be made in any component according to the above-mentioned embodiments, and any component according to the above-mentioned embodiments can be omitted within the scope of the invention.

### INDUSTRIAL APPLICABILITY

Because the navigation device according to the present invention can provide route guidance adapting to a light irradiation state at a guide point to which the vehicle is moving, the navigation device can be used in, for example, a navigation device having a driving support function.

### REFERENCE SIGNS LIST

1 navigation device, 2 map database, 3 input device, 4 sensor group, 5 output device, 5A, 5B guidance screen, 6 image shooting device, 7 communication device, 10, 10A route searching unit, 11 information acquiring unit, 12 light irradiation detecting unit, 13 predicting unit, 14 guidance timing adjusting unit, 15 route guiding unit, 16 output control unit, 20 arrow image, 21a, 21b image information, 22 server, 23 vehicle-mounted device, 100 storage device, 101 touch panel, 102 display, 103 speaker, 104 processing circuit, 105 CPU, 106 memory, 200, 210 communication unit, and 211 output control unit.

1. A navigation device comprising:
a processor to execute a program; and
a memory to store the program which, when executed by the processor, performs processes of,
outputting guidance information about a guide point on a route;
detecting a light irradiation state with respect to a vehicle;
predicting whether a light irradiation state in which a driver feels dazzled will occur at a guide point to which the vehicle is moving, on a basis of the light irradiation state detected; and
changing an output timing of guidance information about the guide point in which occurrence of the light irradiation state in which the driver feels dazzled is predicted, to a second timing earlier than a first timing predetermined for the guide point.

2. The navigation device according to claim 1, wherein the processes further include predicting whether there will occur, at the guide point to which the vehicle is moving, one of a state in which sunlight acts as backlight with respect to a field of view of the driver and a state in which the driver is irradiated with lamp light from an opposite vehicle.

3. The navigation device according to claim 1, wherein information showing a cause that makes the driver feel dazzled is outputted together with the guidance information outputted.

4. The navigation device according to claim 1, wherein the processes further include detecting whether the driver takes a measure to prevent dazzling light, and, when it is detected that the driver takes the measure to prevent dazzling light, the output timing of the guidance information about the guide point to which the vehicle is moving is not changed from the first timing.

5. A server comprising:
a processor to execute a program; and
a memory to store the program which, when executed by the processor, performs processes of,
outputting guidance information about a guide point on a route;
predicting whether a light irradiation state in which a driver feels dazzled will occur at a guide point to which a vehicle is moving, on a basis of information about detection of a light irradiation state with respect to the vehicle;
changing an output timing of guidance information about the guide point in which occurrence of the light irradiation state in which the driver feels dazzled is predicted, to a second timing earlier than a first timing predetermined for the guide point; and
communicating with a vehicle-mounted device, to transmit the guidance information outputted.

6. A navigation method comprising:
outputting guidance information about a guide point on a route;
detecting a light irradiation state with respect to a vehicle;
predicting whether a light irradiation state in which a driver feels dazzled will occur at a guide point to which the vehicle is moving, on a basis of the light irradiation state detected; and
changing an output timing of guidance information about the guide point in which occurrence of the light irradiation state in which the driver feels dazzled is predicted, to a second timing earlier than a first timing predetermined for the guide point.
